(19) United States
(12) Patent Application Publication
(10) Pub. No.: US 2026/0283249 A1
(43) Pub. Date: Sep. 24, 2026

(54) Aerosol Generating Device Comprising a 3D Printed Ceramic Cup and Associated Method for Producing

(71) Applicant: JT International SA, Geneva (CH)

(72) Inventors: Alec Wright, Guildford (GB); Jaakko McEvoy, Wien (AT)

(73) Assignee: JT International SA, Geneva (CH)

(21) Appl. No.: 19/479,592

(22) PCT Filed: Apr. 30, 2024
(86) PCT No.: PCT/EP2024/061944

§ 371 Date: Oct. 28, 2025

(30) Foreign Application Priority Data
May 2, 2023 (EP) 23170971.8

(51) Int. Cl. A24F 40/465; A24F 40/20; A24F 40/70

(52) U.S. Cl. CPC A24F 40/465; A24F 40/70; A24F 40/20

(57) ABSTRACT

A heating assembly for an aerosol generating device, includes a heating chamber having an opening for receiving an aerosol generating article, the heating chamber including a tubular portion made from a predetermined ceramic material and forming a ceramic cup, wherein the ceramic cup is a 3D printed ceramic cup based on a slurry corresponding to a mix of the predetermined ceramic material with a polymer.

### FIELD OF THE INVENTION

The present invention relates to a heating assembly for an aerosol generating device and an aerosol generating device comprising such a heating assembly. The disclosure is particularly applicable to a portable aerosol generating device, which may be self-contained and low temperature.

Particularly, the aerosol generating device according to the invention is configured to operate with a tobacco article, also called aerosol generating article, which comprises for example a solid substrate able to form aerosol when being heated. Thus, such type of aerosol generating devices, also known as heat-not-burn devices, is adapted to heat, rather than burn, the substrate by conduction, convection and/or radiation, to generate aerosol for inhalation.

The present invention also concerns a method for producing a heating chamber of heating assembly for an aerosol generating device.

### BACKGROUND OF THE INVENTION

The popularity and use of reduced-risk or modified-risk devices (also known as vaporisers) has grown rapidly in the past few years as an aid to assist habitual smokers wishing to quit smoking traditional tobacco products such as cigarettes, cigars, cigarillos, and rolling tobacco. Various devices and systems are available that heat or warm vaporizable substances as opposed to burning tobacco in conventional tobacco products.

A commonly available reduced-risk or modified-risk device is the heated substrate aerosol generation device or heat-not-burn device. Devices of this type generate aerosol or vapour by heating an aerosol substrate (i.e. an aerosol generating article) that typically comprises moist leaf tobacco or other suitable vaporizable material to a temperature typically in the range 150° C. to 350° C. Heating an aerosol substrate, but not combusting or burning it, releases aerosol that comprises the components sought by the user but not the toxic and carcinogenic by-products of combustion and burning. Furthermore, the aerosol produced by heating the tobacco or other vaporizable material does not typically comprise the burnt or bitter taste resulting from combustion and burning that can be unpleasant for the user and so the substrate does not therefore require the sugars and other additives that are typically added to such materials to make the smoke and/or vapour more palatable for the user.

Some of known aerosol generating devices operating with tobacco article comprise a heater which consumes a lot of energy to bring the heater up to a predefined temperature and thus to heat the tobacco article to the target temperature.

For heating an aerosol substrate, there are known heating assemblies comprising a heating chamber for receiving the aerosol substrate and heating elements for heating the heating chamber. The heating chamber is generally made from stainless steel. A thin-film metal heater to produce the heat and a graphite layer to spread the heat are both wrapped around the heating chamber made from stainless steel, said stainless steel cup holding the aerosol generating article.

However, this heating chamber is not completely satisfying since it requires in particular a graphite layer, which does not spread efficiently the heat in the transverse direction in comparison with the longitudinal spread of the heat in an axial direction, while it is precisely the heat spread in the transverse direction which travels the aerosol generating article, such as tobacco. Moreover, the stainless steel cup as such presents a poor thermal conductivity.

Other heating chambers are made from materials with properties that enhance the heating of the aerosol substrate and thus enhance the user experience.

For example, there are known heating chambers, made from a ceramic material, and thus require significant energy to reach a vaporization temperature. Moreover, for heating chambers made from a ceramic material, the heat is distributed homogeneously, which does not allow targeting of a specific region of the heating chamber.

As a first solution, said heating chambers, made from a ceramic material, are generally interface with additional components to produce a full heater assembly, but the challenge here is joining together the ceramic heating part with these additional components which produce additional steps and complexity to design.

As a second solution, said heating chambers, made from a ceramic material have the heating element within the ceramic, however such an arrangement limits the production methods to tape casting or cast moulding, and thus limits the complexity of the geometry and the total wall thickness and also increases the energy consumption of the device.

### SUMMARY OF THE INVENTION

The invention aims first of all at solving, at least in part the drawbacks of the prior art. The invention also aims to produce a heating assembly with low complexity and reduced cost, while maintaining high performance and increased efficiency and providing improved sensory performance.

For this purpose, the invention relates to heating assembly for an aerosol generating device comprising a heating chamber having an opening for receiving an aerosol generating article, said heating chamber comprising:
a tubular portion made from a predetermined ceramic material and forming a ceramic cup, wherein said ceramic cup is a 3D printed ceramic cup based on a slurry corresponding to a mix of said predetermined ceramic material with a polymer.

In other words, said heating chamber comprises a ceramic cup formed, at least in part, by a tubular portion made from a predetermined ceramic material, and said ceramic cup is a 3D printed ceramic cup based on a slurry corresponding to a mix of said predetermined ceramic material with a polymer.

It has to be noted that the term “cup” is clear for the one skilled in the art familiar with the known heating assemblies for heating an aerosol substrate, especially the ones which comprises a stainless cup and means a “container” configured for holding the aerosol generating article. Such a container can be opened at either or both ends of the tube as further described.

Thanks to these features, in comparison with the heating assemblies of the prior art with a heating chamber generally made from stainless steel, the proposed 3D printed ceramic cup is proposed as an alternative to the stainless steel cup. In other words, a graphite layer may be no longer required in the present proposed heating assembly, as the ceramic material of the 3D printed ceramic cup has a thermal conductivity significantly higher than a stainless steel cup. Such a thermal conductivity of the 3D printed ceramic cup allows the efficient transfer of heat longitudinally in an axial direction of the heating chamber. Indeed, the 3D printed ceramic cup can store more thermal energy and heat more homogeneously the tobacco portion. Notwithstanding the above, the proposed 3D printed ceramic cup may also be provided with a graphite sheet for further enhancing the heat spreading effect.

In addition, such a thermal conductivity of the 3D printed ceramic cup also allows the 3D printed ceramic cup to present a larger wall thickness in comparison with the heating assemblies of the prior art with an heating chamber generally made from stainless steel. Indeed, a larger wall thickness of the 3D printed ceramic cup still provide the same heat transfer from the thin film heating element to the tobacco article. Moreover, such a larger wall thickness in comparison with the heating assemblies of the prior art with an heating chamber improves the durability of the 3D printed ceramic cup when considering that although the ceramic is very hard, the ceramic is more brittle, so a thicker wall improves its durability.

The 3D printed ceramic cup is based on a slurry corresponding to a mix of said predetermined ceramic material with a polymer and can be printed easily into complex geometries. Said 3D printed ceramic cup is wrapped in a thin film heating element to obtain the heating assembly, without needing to interface it with the additional components of the prior art and avoiding tape casting or cast moulding required to insert the heating element within the ceramic.

In some embodiments, said 3D printed ceramic cup presents at least one element belonging to the group comprising:
a predetermined shape;
a wall thickness adapted and optimized depending on the type of said predetermined ceramic material.

Indeed such a 3D printed ceramic cup can be printed easily into complex geometries, which is not always possible when using a moulding method, and it is easier to adapt and optimise the wall thickness depending on the type of said ceramic material. More precisely, with 3D printing the complexity may be high and wall thickness may be very low over small areas. Thus, according to these embodiments, a 3D printed ceramic cup permits in most cases to provide additional features, which can not be obtained using a traditional moulding method.

In some embodiments, said wall thickness is less than 1 mm and greater or equal to 0.3 mm.

Thanks to these features, a 3D printed ceramic cup can be printed easily and permits to obtain a wall thickness that may be very low over small areas, but if the thickness is too small (i.e. less than 0.3 mm) then it cannot be printed.

In some embodiments, the heating assembly, further comprises a heating element, configured to heat said tubular portion, wherein said heating element belonging to the group comprising at least:
a thin film heating element, said tubular portion being wrapped in said thin film heating element;
an inductively heatable susceptor attached to the cup;
a heater track printed directly onto the cup.

Thanks to these features, several heater options are provided.

Some embodiments, said predetermined ceramic material is aluminium nitride.

A ceramic material corresponding to Printed Aluminium Nitride (Printed AlN) has a thermal conductivity of 163.1 W/m·K, which is indeed significantly higher than the one of a stainless steel 316L equal to 16.3 W·m⁻¹·K⁻¹, which allows the efficient transfer of heat longitudinally and avoids the use of a graphite layer to spread the heat. Indeed, with a graphite layer, the thermal spread in the longitudinal direction is important, but poor in the transverse direction (in relation to the longitudinal axial direction), while it is precisely the heat spread in the transverse direction which is of interest since it travels the aerosol generating article, such as tobacco.

In other words, the proposed 3D printed AlN ceramic cup is efficient to spread the heat in all directions, while a stainless steel 316L cup is poor in all directions, even if being associated with a graphite layer, which remains poor in the transverse direction of spreading the heat, which is precisely the direction of interest.

In addition, such a thermal conductivity of 163.1 W/m·K of Printed Aluminium Nitride (Printed AlN), leads, for a same type of aerosol generating device, to a larger wall thickness of 0.9 mm instead of 0.08 mm with a stainless steel 316L cup, said larger wall thickness of 0.9 mm providing an equivalent thermal resistance.

In some embodiments, said predetermined ceramic material is Silicon Carbide.

Silicon carbide (SiC) is an alternative to Aluminium Nitride (AlN) according to the previous embodiments. As other alternatives, silicon nitride (Si2N4) or beryllium oxide (BeO) can also be used. Indeed, such ceramic materials SiC, AlN, Si2N4 or BeO are ceramics with higher thermal conductivities compared to Alumina oxide or Zirconia for example and are therefore more suited for the present application.

Aluminum nitride is preferred in this application for obtaining said 3D printed ceramic cup since Sic has a lower thermal conductivity.

According to some embodiments, said ceramic cup presents a ceramic wall thickness greater than or equal to a predetermined thickness threshold, said predetermined thickness threshold being obviously not null. In other words said ceramic cup presents a ceramic wall thickness greater than a predetermined thickness threshold if this predetermined thickness threshold is equal to zero.

Thanks to these features, the durability of the 3D printed ceramic cup is improved when considering that although the ceramic is very hard, the ceramic is more brittle, so a thicker wall improves its durability. Ideally, the thickness is less than 1 mm, more ideally less than 0.7 mm, more ideally 0.3-0.5 mm.

According to some embodiments, said thickness threshold depends on the type of said predetermined ceramic material.

Indeed, since said ceramic cup is 3D printed, it is easier to adapt and optimise the thickness depending on the type of said ceramic material. Indeed, with 3D printing the complexity may be high and wall thickness may be very low over small areas, but if the thickness is too small then it cannot be printed.

According to some embodiments, said ceramic cup presents an oblong shaped section in an axial direction, said oblong shaped section being formed by two parallel flat surfaces joined by two curved surfaces, or joined by two straight surfaces with small radius at the edges, or any other feature configured to add compression.

Indeed, since said ceramic cup is 3D printed, such a complex shape can be formed with repeatability, which would be impossible via traditional casting/molding processes. Using such a 3D printed ceramic cup has additional benefits in the heated tobacco device having a flat shape, in comparison with the heating assemblies of the prior art with a heating chamber generally made from stainless steel. Indeed, the large features to add compression, with the thinner wall thickness required in a stainless steel cup, to allow an efficient heat transfer, are challenging to produce, structurally weak and likely to flex during heating. As used herein, the term “features to add compression” covers all shapes that would add compression and selective points around the aerosol generating material rod, e.g. tobacco rod.

According to another aspect, the present invention also relates to an aerosol generating device comprising a battery and a heating assembly as recited above, wherein a heating element is electrically supplied by the battery.

The aerosol generating device presents the same advantages as the ones described in relation with the heating assembly.

The invention also relates to a method for producing a heating chamber of a heating assembly for an aerosol generating device as recited above, said heating chamber having an opening for receiving an aerosol generating article, said method comprising a step of 3D printing a tubular portion made from a predetermined ceramic material and forming a 3D printed ceramic cup based on a slurry corresponding to a mix of said predetermined ceramic material with a polymer.

According to some embodiments, the method further comprises the step of associating said tubular portion with a heating element, configured to heat said tubular portion, said heating element belonging to the group comprising at least:
a thin film heating element, said tubular portion being wrapped in said thin film heating element;
an inductively heatable susceptor attached to the cup;
a heater track printed directly onto the cup.

According to some embodiments, said step of 3D printing a tubular portion comprises the following successive sub-steps:

mixing the predetermined ceramic material of said tubular portion with a polymer to create said slurry; printing said slurry using a 3D printing substantially corresponding to an SLA printing, or as a filament, by using a thermal treatment associated to said polymer, said thermal treatment holding a predetermined shape;

sintering said predetermined shape by debinding said polymer at a predetermined temperature and fusing together the individual ceramic particles which were suspended in the slurry, to obtain said tubular portion as a finished part.

### BRIEF DESCRIPTION OF THE DRAWINGS

The invention and its advantages will be better understood upon reading the following description, which is given solely by way of non-limiting example and which is made with reference to the appended drawings, in which:

FIG. 1 is a perspective view of a heating assembly according to a first embodiment of the invention;

FIGS. 2 and 3 are respectively a perspective front view and a perspective cross-sectional view of other heating assemblies according to other embodiments of the invention;

FIG. 4 corresponds to a flowchart of a method for producing a heating chamber of a heating assembly for an aerosol generating device.

### DETAILED DESCRIPTION OF THE INVENTION

Before describing the invention, it is to be understood that it is not limited to the details of construction set forth in the following description. It will be apparent to those skilled in the art having the benefit of the present disclosure that the invention is capable of other embodiments and of being practiced or being carried out in various ways.

The expression “substantially equal to” is understood hereinafter as an equality at plus or minus 10% and preferably at plus or minus 5%.

As used herein, the term “aerosol generating device” or “device” may include a vaping device to deliver an aerosol to a user, including an aerosol for vaping, by means of a heater element explained in further detail below. The device may be portable. “Portable” may refer to the device being for use when held by a user. The device may be adapted to generate a variable amount of aerosol, e.g. by activating the heater element for a variable amount of time (as opposed to a metered dose of aerosol), which can be controlled by a trigger. The trigger may be user activated, such as a vaping button and/or inhalation sensor. The inhalation sensor may be sensitive to the strength of inhalation as well as the duration of inhalation to enable a variable amount of vapour to be provided (so as to mimic the effect of smoking a conventional combustible smoking article such as a cigarette, cigar or pipe, etc.). The device may include a temperature regulation control to drive the temperature of the heater and/or the heated aerosol generating substance (aerosol pre-cursor) to a specified target temperature and thereafter to maintain the temperature at the target temperature that enables efficient generation of aerosol.

As used herein, the term “aerosol” may include a suspension of vaporizable material as one or more of: solid particles; liquid droplets; gas. Said suspension may be in a gas including air. Aerosol herein may generally refer to/include a vapour. Aerosol may include one or more components of the vaporizable material.

As used herein, the term “vaporizable material” or “precursor” may refer to a smokable material which may for example comprise nicotine or tobacco and an aerosol former. Tobacco may take the form of various materials such as shredded tobacco, granulated tobacco, tobacco leaf and/or reconstituted tobacco. Suitable aerosol formers include: a polyol such as sorbitol, glycerol, and glycols like propylene glycol or triethylene glycol; a non-polyol such as monohydric alcohols, acids such as lactic acid, glycerol derivatives, esters such as triacetin, triethylene glycol diacetate, triethyl citrate, glycerin or vegetable glycerin. In some embodiments, the aerosol generating agent may be glycerol, propylene glycol, or a mixture of glycerol and propylene glycol. The substrate may also comprise at least one of a gelling agent, a binding agent, a stabilizing agent, and a humectant.

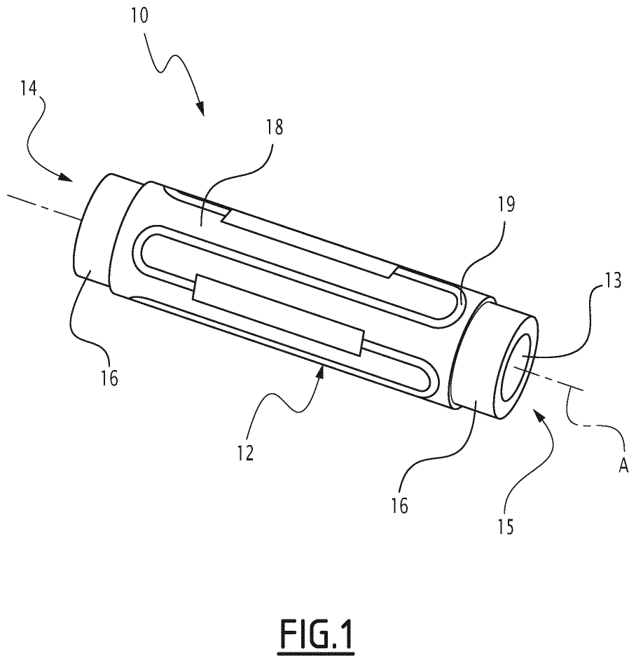

FIG. 1 shows a heating assembly of an aerosol generating device (not represented as such).

The aerosol generating device is a heat-not-burn device, which may also be referred to as a tobacco-vapour device or heated tobacco device, and comprises a heating assembly 10 and a battery (not represented as such) electrically connected to the heating assembly 10.

The heating assembly 10 is configured to receive an aerosol substrate such as a rod of aerosol generating material, e.g. tobacco. The heating assembly is also configured to convert electrical energy supplied by the battery into thermal energy. To this end, the heating assembly 10 is operable to heat, but not burn, the rod of aerosol generating material to produce a vapour or aerosol for inhalation by a user. Of course, the skilled person will appreciate that the aerosol generating device is simply an exemplary aerosol generating device according to the invention. Other types and configurations of tobacco-vapour products, vaporisers, or electronic cigarettes may also be used as the aerosol generating device according to the invention.

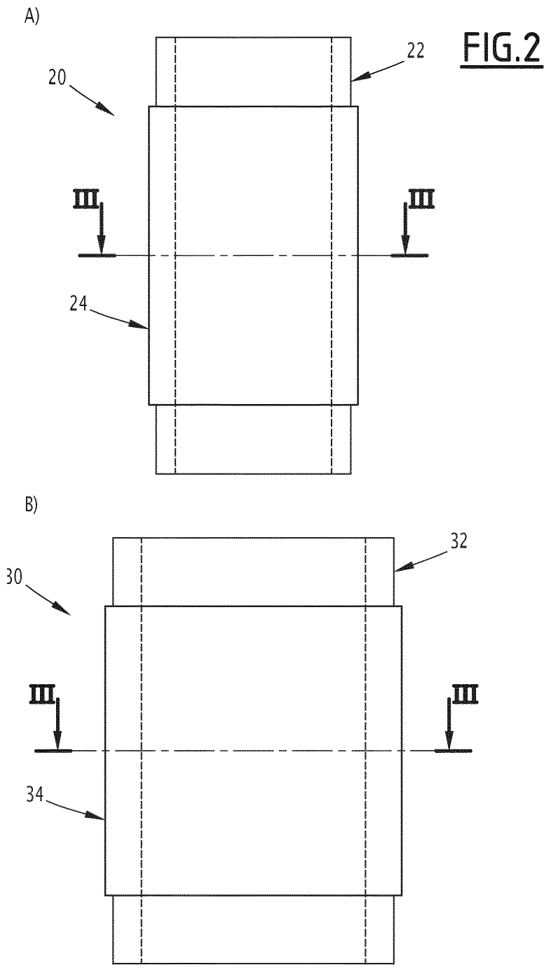

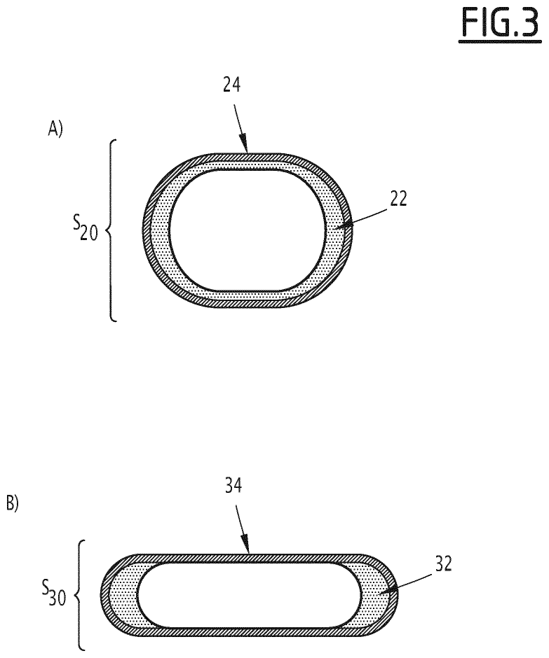

Tobacco articles, usable with such type of aerosol generating devices can take various forms. Some of them can present an elongated stick or any other suitable shape, like for example a flat shape as illustrated later in relation with FIGS. 2 and 3. However, design of a tobacco article is often a trade-off between its aesthetics and efficiency in heating.

The heating assembly 10 comprises a heating chamber 12, also referred to as a thermally conductive shell or cup, configured to hold an aerosol generating article, also referred to as a consumable, or as an aerosol substrate. In particular, the heating chamber 12 defines here a substantially cylindrical cavity or cup in which a rod of aerosol substrate may be positioned.

The heating chamber 12 is tubular, e.g. substantially cylindrical, and defines a central passage 13 open to a first end 14 of the heating chamber 12 and a second end 15 of the heating chamber 12, axially opposite the first end 14. In other words, the central passage 13 is accessible from each of the first end 14 and the second end 15 via openings.

Alternatively, the central passageway may have only one opening located at either of the first end and the second end of the heating chamber 12.

In use, the user may insert the aerosol substrate through an opening in the heating chamber 12 such that the aerosol substrate is positioned within the heating chamber 12 and interfaces with an inner surface of the heating chamber 12.

The length of the heating chamber 12 may be configured such that a portion of the aerosol substrate protrudes through an opening from the heating chamber 12, i.e. out of the heating assembly 10, and can be received in the mouth of the user.

According to the invention, the heating chamber 12 includes a tubular portion 16 made from a predetermined ceramic material and forming a ceramic cup, wherein said ceramic cup is a 3D printed ceramic cup based on a slurry corresponding to a mix of said predetermined ceramic material with a polymer.

The heating chamber 12 includes also a heating element, configured to heat said tubular portion, said heating element corresponding to a thin film heating element.

### The Tubular Portion 16 Is Wrapped in Said Thin Film Heating Element 18.

The tubular portion 16 has here a circular cross-section and also has a first end and a second end axially opposite to the first end. In other words, the tubular portion 16 is tubular, e.g. substantially cylindrical.

Alternatively, as represented later in relation with FIG. 2, the tubular portion 16 comprises one or more flattened regions that extend in an axial direction of the heating chamber 12.

The tubular portion 16 is made from a ceramic material, and preferably aluminum nitride (abbreviated as AlN) in the illustrated example. Due to its construction of a ceramic material, the first tubular portion 16 has high thermal mass and provides good heat penetration into the aerosol substrate, especially when said aerosol substrate includes tobacco. This allows for improved sensory performance with a fuller vapor and a higher nicotine level when the aerosol substrate contains tobacco.

The thin film heating element 18 comprises a heating element 19 configured to act as a Joule heater when supplied with electrical current. In other words, the heating element 19 is configured to release heat in response the flow of electrical current. This physical effect may be referred to as Joule heating, resistive heating or ohmic heating. In use, power may be supplied to the heating element 19 from the battery for example, such that the temperature of the heating element 19 increases and heat energy is transferred across the heating chamber 12 and more particularly to the tubular portion 16. The aerosol substrate received within the heating assembly is conductively heated by the heating chamber 16 to produce an aerosol for inhalation by the user.

More precisely, said thin film heater comprises for example a metal heater track.

Said metal heater presents a thickness between 5 μm and 100 μm, and is electrically isolated by one or more layers of insulating materials such polyimide, Typically, the metal heater track is sealed between two layers of polyimide. Each layer of the insulating material presents a thickness, which is approximately between 20 μm and 50 μm. The thin film heater is flexible due to the thin nature of all these precited components and can be wrapped around other components and held in place either by an adhesive or by an additional polyimide tape around it to secure in place, or both at the same time.

In the example of FIG. 1, the length of the film heating element 18 is less than the length of the tubular portion 16 and the position of the film heating element 18 is central along the longitudinal axis.

Indeed, there is generally some additional material of the tubular section left which is not covered by the thin film heater 18 to allow for attachment to other components (note represented), as well as to reduce the temperature before attaching to other components which may not have the same high temperature resistance as ceramic, e.g., PEEK or other polymers.

The location of the thin film heating element 18 along the cup is not critical, but is located in such a position that it correlates with the tobacco portion in the consumable which is inserted into the tubular portion 16. This is because the heating of the tobacco is targeted. Preferred dimensions of the 3D printed ceramic cup according to the present disclosure, would be, for example, an inner height between 1.6 and 1.7 mm, an inner width between 12 and 15 mm, inner edge radius between 0.1 and 0.5 mm and external edge radius of between 0.1 and 0.5 mm in addition to the wall thickness, and a wall thickness between 0.3 and 1 mm. The less material that can be used, means the less thermal energy is required to heat the 3D printed ceramic cup and the faster the set temperature can be achieved when in use. The 3D printed ceramic cup's mass has to be high enough though to ensure the cup does not break due to brittleness.

The heating element 19 is here wrapping an outer surface of the tubular portion 16 forming said ceramic cup.

The heating element 19 is here formed as a meandrous or serpentine pattern coating on the outer surface of the tubular portion 16 forming said ceramic cup.

For example, the heating element 19 may be shaped by etching, masking, laser cutting, or stamping cutting to form the illustrated pattern. Of course, the skilled person will appreciate that the specific pattern formed by the heating element 19 may vary, depending on the functional requirements of the heating assembly. The pattern forms an electrical path such that, in use, electrical current supplied from the battery to the heating element 19 travels along the electrical path and generates heat energy. The heating element 19 is made from any material that acts as a Joule heater when supplied with an electric current, such as tungsten for example. Other materials having a coefficient of thermal expansion substantially matching that of the ceramic material may be considered.

When the heating element 19 is powered by an electric current supplied by the battery of the aerosol generating device, this heating element 19 converts the electric energy into heat, which is transmitted by conduction to the tubular portion 16 forming said ceramic cup. It has to be noted that said thin-film heater providing said heating element 19, can be replaced by other types of heating element, which could also be an inductively heatable susceptor attached to the 3D printed ceramic cup (not represented) or a heater track printed directly onto the 3D printed ceramic cup (not represented). For example, the inductively heatable susceptor can take a tubular shape which surrounds at least part of the 3D printed ceramic cap.

FIG. 2 illustrates that the proposed 3D printed ceramic cup is compatible with different geometries of the aerosol generating device. More particularly, in FIG. 2, the aerosol generating device according to the invention is configured to operate with a tobacco article, for example a flat-shaped tobacco article.

In FIG. 2, two designs of such aerosol generating device configured to operate with a flat-shaped tobacco article are represented.

The first design 20 corresponds to a heated tobacco device having a substantially circular or oval cross-section.

In the front view in FIG. 2 of said first design 20, the 3D ceramic cup 22 is wrapped in the thin film heating element 24, as confirmed in the cross-sectional view A illustrating the cross-section S20 of FIG. 3.

The second design 30 corresponds to a heated tobacco device having a substantially flat-shaped cross-section.

In the front view in FIG. 2 of said second design 30, the 3D ceramic cup 32 is also wrapped in the thin film heating element 34, as confirmed in the cross-sectional view B illustrating the cross-section S30 of FIG. 3.

As shown in FIGS. 2 and 3, both designs 20 and 30 share common features wherein said ceramic cup 22 and 32 presents a same wall thickness for the whole circumference (said thickness being not represented as such), and an oblong shaped section in an axial direction, said oblong shaped section being formed by two parallel flat surfaces joined by two curved surfaces, or joined by two straight surfaces with small radius at the edges, or any other feature configured to add compression.

Preferably, said ceramic material is made from Aluminium Nitride, or from Silicon Carbide.

Said 3D printed ceramic cup presents advantageously a ceramic wall thickness greater than or equal to a predetermined thickness threshold.

Optionally, said thickness threshold depends on the type of said predetermined ceramic material.

According to a particular example, when said 3D printed ceramic cup is made from Printed Aluminium Nitride presenting a thermal conductivity of 163.1 W/m·K, which is indeed significantly higher than the one of a stainless steel 316L equal to 16.3 W·m⁻¹·K⁻¹, said thermal conductivity allows the efficient transfer of heat longitudinally and avoids the use of a graphite layer to spread the heat.

In addition, such a thermal conductivity of 163.1 W/m·K of Printed Aluminium Nitride (Printed AlN), leads, for a same design 20, to a larger wall thickness of 0.9 mm instead of 0.08 mm with a stainless steel 316L cup, said larger wall thickness of 0.9 mm still providing the same heat transfer from the thin film heating element to the tobacco article.

The design 30 of the proposed 3D printed cup has additional benefits in comparison with the heating assemblies of the prior art with an heating chamber generally made from stainless steel and presenting the same design shape. Indeed, the large flat features with the thin wall thickness, usually between 50 μm and 200 μm and generally closer to 100 μm, e.g. 0.075 mm, required by a stainless steel cup are challenging to produce and structurally weak since they are likely to flex during heating.

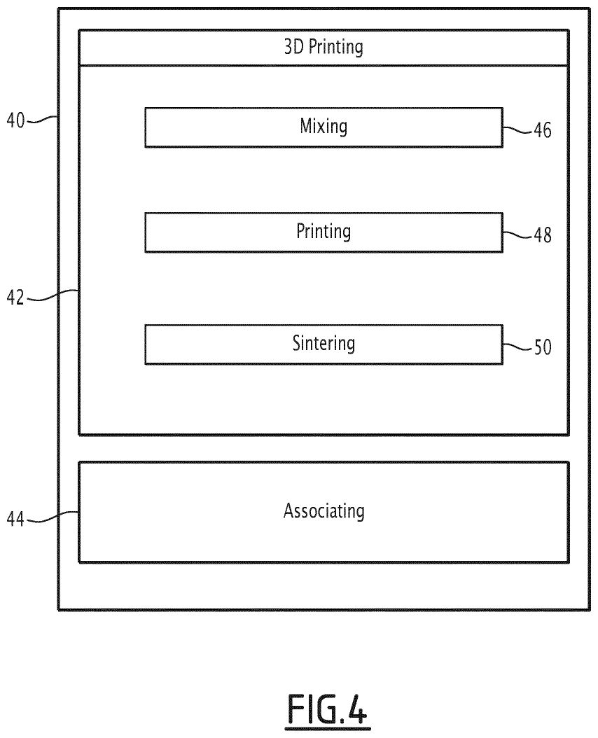

The method 40 for producing a heating chamber of a heating assembly for an aerosol generating device, said heating chamber having an opening for receiving an aerosol generating article will now be described in reference to FIG. 4 illustrating a flowchart of its steps.

During a first step 42, a tubular portion made from a predetermined ceramic material is 3D printed, to form a 3D printed ceramic cup based on a slurry corresponding to a mix of said predetermined ceramic material with a polymer.

During a second step 44, said tubular portion is associated with in a heating element, configured to heat said tubular portion, said heating element belonging to the group comprising at least:
a thin film heating element, said tubular portion being wrapped in said thin film heating element ;
an inductively heatable susceptor attached to the cup;
an heater track printed directly onto the cup.

As shown in the embodiment of FIG. 4, said step 42 of 3D printing a tubular portion comprises the following successive sub-steps:
mixing 46 the predetermined ceramic material of said tubular portion with a polymer to create said slurry;
printing 48 said slurry using preferentially a 3D printing substantially corresponding to an SLA printing (wherein SLA stands for StereoLitography Apparatus) or a LCM printing (wherein LCM stands for Lithography-based Ceramic Manufacturing), or as a filament, and by using a thermal treatment associated to said polymer, said thermal treatment holding a predetermined shape;
sintering 50 said predetermined shape by debinding said polymer at a predetermined temperature and fusing together the individual ceramic particles which were suspended in the slurry, to obtain said tubular portion as a finished part.

A LCM approach is preferentially used for high precision and mass manufacturing, or any future approach improving precision and masse manufacturing.

For example, the slurry is premixed in bottles and the mix of ceramic to binder is predetermined as a function of a corresponding application.

For example (not limitative), the slurry comprises four compounds listed in the following percentages: AlN with a percentage of 50-100%, two types of polymer respectively representing 10-25% and 5-10%, and a reactive hardener with a percentage inferior to 0.25%.

In other words, said slurry comprises mainly the ceramic material mixed with at least one minority polymer and with a reactive hardener in extremely small quantities (i.e. less than one percent).

The slurry would be poured into the printing bed of a 3D printed machine. Preferentially, the printers usually operate the same way as SLA (wherein SLA stands for StereoLitography Apparatus) with a layer of resin/slurry being UV cured by a laser or other light source, before another layer of resin/slurry being applied/moved onto the part and cured again. These layers are usually in the micron to tens of microns. Duration depends on the layer size, number of parts on the print bed and the size of the part.

Alternatively, the slurry is printed as a filament, but this approach is less accurate than using 3D printing substantially corresponding to an SLA printing.

Concerning the sintering step 50, generic sintering temperature of the ceramic material, such as AlN, is 1400-2000° C. The polymer is debinded usually at around 600° C. and then the individual ceramic particles, which were suspended in the slurry, are fused together during said the sintering step 50.

More precisely, according to this example, AlN is usually sintered at above 1600° C. so that all polymer is burnt out. Indeed, if sintered at lower temperatures e.g., 1100° C. all polymer is burnt out still, but the resulting ceramic will be porous, which is not expected for the present application, wherein high density low porosity material with high thermal conductivity is, on the contrary, required.

AlN is usually required to be sintered in inert Nitrogen environment, unlike other ceramics. To prevent thermal shock to the sintered part a slow ramp in temperature is used. This ramp depends on the part size being cured, with smaller parts requiring slower ramp rates. An example of a [symbol] standard [symbol] ramp rate would be 10° C./minute up to final temperature for example of 1700° C. and then holding for extended time (depends on part size, but usually around six to twelve hours) before ramping down slowly to ambient conditions.

The one skilled in the art will understand that the disclosure is not limited to the embodiments described, nor to the particular examples of the specification, the above-mentioned embodiments and variants being suitable for being combined with each other to generate new embodiments of the disclosure.

Thanks to the invention, the heating assembly 10, and more particularly the 3D printed ceramic cup is produced with a reduced cost, is compatible with different and complex geometries while improving sensory performance and durability.

1. A heating assembly for an aerosol generating device, comprising:
a heating chamber having an opening for receiving an aerosol generating article, said heating chamber comprising:
a tubular portion made from a predetermined ceramic material and forming a ceramic cup, wherein said ceramic cup is a 3D printed ceramic cup comprising a slurry including a mix of said predetermined ceramic material with a polymer.

2. The heating assembly according to claim 1, wherein said 3D printed ceramic cup includes at least one of:
a predetermined shape; or
a wall thickness configured to correspond with the type of said predetermined ceramic material.

3. The heating assembly according to claim 1, wherein said 3D printed ceramic cup has a wall thickness less than 1 mm and greater or equal to 0.3 mm.

4. The heating assembly according to claim 1, to further comprising a heating element, configured to heat said tubular portion, wherein said heating element is at least one of:
a film heating element, said tubular portion being wrapped in said film heating element;
an inductively heatable susceptor attached to the cup; or
a heater track printed directly onto the cup.

5. The heating assembly according to claim 1, wherein said predetermined ceramic material is Aluminium Nitride.

6. The heating assembly according to claim 1, to wherein said predetermined ceramic material is Silicon Carbide.

7. The heating assembly according to claim 1, wherein said ceramic cup includes a ceramic wall thickness greater than or equal to a predetermined thickness threshold.

8. The heating assembly according to claim 7, wherein said thickness threshold depends on the type of said predetermined ceramic material.

9. The heating assembly according to claim 1, wherein said ceramic cup includes an oblong shaped section in an axial direction, said oblong shaped section being formed by two parallel flat surfaces joined by two curved surfaces, or joined by two straight surfaces with radius at the edges,

10. An aerosol generating device comprising a battery and the heating assembly according to claim 1, wherein said heating element is electrically supplied by the battery.

11. A method for producing a heating chamber of a heating assembly for an aerosol generating device, said heating chamber having an opening for receiving an aerosol generating article, said method comprising a step of 3D printing a tubular portion made from a predetermined ceramic material and forming a 3D printed ceramic cup comprising a slurry including a mix of said predetermined ceramic material with a polymer.

12. The method according to claim 11, further comprising the step of associating said tubular portion with a heating element, configured to heat said tubular portion, said heating element is at least one of:
a film heating element, said tubular portion being wrapped in said thin film heating element;
an inductively heatable susceptor attached to the cup; or
a heater track printed directly onto the cup.

13. The method according to claim 11, wherein said step of 3D printing the tubular portion comprises the following successive sub-steps:
mixing the predetermined ceramic material of said tubular portion with the polymer to create said slurry;
printing said slurry using a 3D printing substantially corresponding to an SLA printing, or as a filament, by using a thermal treatment associated to said polymer, said thermal treatment holding a predetermined shape; and
sintering said predetermined shape by debinding said polymer at a predetermined temperature and fusing together individual ceramic particles which were suspended in the slurry, to obtain said tubular portion as a finished part.
